(19) United States
(12) Patent Application Publication
(10) Pub. No.: US 2025/0381897 A1
(43) Pub. Date: Dec. 18, 2025

(54) HOLDING ROD FOR A HEAD RESTRAINT

(71) Applicant: Adient US LLC, Plymouth, MI (US)

(72) Inventors: Michal MARTINKA, Nove Mesto nad Vohom (SK); Christophe FRITSCH, Souffelweyersheim (FR)

(21) Appl. No.: 19/237,102

(22) Filed: Jun. 13, 2025

(30) Foreign Application Priority Data
Jun. 14, 2024 (DE) 10 2024 205 518.2

(51) Int. Cl. B60N 2/894

(52) U.S. Cl. CPC B60N 2/894

(57) ABSTRACT

A holding rod for a head restraint, where the holding rod is provided with a hollow bore at a free rod end. A mounting part is inserted into the hollow bore and is joined to the free rod end. A head restraint and a vehicle seat with the head restraint are also provided.

### FIELD

The invention relates to a holding rod for a head restraint, to a head restraint, and to a vehicle seat.

### BACKGROUND

Holding rods for a head restraint are known in the prior art. The head restraint is held on a vehicle seat by the holding rods. For example, the holding rods are attached to an upper backrest frame in the vehicle seat. Major mechanical stresses may cause the attachment of the holding rods on the backrest frame to be loosened.

The invention is based on the problem of providing a head restraint holding rod which is designed to be particularly robust in relation to mechanical stresses, and of providing a head restraint having such an improved holding rod, and a corresponding vehicle seat.

The first problem mentioned is solved according to the invention by a holding rod having the features of claim 1. The second problem mentioned is solved according to the invention by a head restraint having the features of claim 9. The third problem mentioned is solved according to the invention by a vehicle seat having the features of claim 10.

The holding rod according to the invention for a head restraint is provided with a hollow bore at a freely accessible rod end and can optionally be countersunk, wherein a mounting part, in particular a press-fit nut or rivet nut, is inserted into the hollow bore and is joined to the rod end, in particular pressed in, tightened or riveted.

The freely accessible rod end of the holding rod can, for example, be additionally countersunk, compressed, beveled, chamfered or undercut. This simplifies the insertion of the mounting part and can be done in particular without clamping.

The mounting part (also called insert part or additional part) may in particular have an internal thread. This means that a fastening means, such as a screw element, in particular a threaded bolt or a threaded screw, can be connected to the holding rod in a simple manner with a form-fit and force-fit.

The mounting part may, for example, have an internal portion (also called an internal mounting portion), which, in the assembled state, is arranged in the hollow bore. Furthermore, the mounting part may have an external portion, which, in the assembled state, protrudes from the hollow bore of the holding rod.

For example, the external portion of the mounting part may be in the form of a flange or an edge protruding at a right angle. As a result, the mounting part, when connected, can lie flush, for example, against a screw head of the screw element.

In addition, the mounting part may be provided with a profile, in particular longitudinal grooves or the like, for example in sections on the outside.

The press-fit nut may be pressed into the hollow bore, for example, in alignment with the hollow bore. Alternatively, the rivet nut may be provided, for example, with a flat head or with a countersunk head, which lies against the end face of a hollow bore edge of the free rod end or in a hollow bore depression of the free rod end. In addition, the press-fit nut or the rivet nut may be provided in sections on the outside with a profile, in particular with longitudinal grooves. The press-fit nut or rivet nut may be provided, for example, with a standard thread, in particular an M9 thread or D9 thread.

The second problem mentioned is solved according to the invention by the head restraint, which has a head restraint body and the at least one holding rod for holding the head restraint body, wherein the holding rod, for example, may be in the form of an I-profile with a free rod end or a U-profile with two free rod ends.

The third problem mentioned is solved according to the invention by the vehicle seat having the above-described head restraint, which comprises the at least one previously described holding rod, the free rod end of which is attached to a holder by a screw element, for example, a screw or screw bolt, which is inserted into the mounting part or insert part, in particular screwed into the press-fit nut or into the rivet nut, in particular tightened onto the free rod end.

### SUMMARY

The fact that the previously described mounting part, such as a press-fit nut or a rivet nut (also called a locking nut or rivet nut), is inserted into the rod end and joined to the rod end, in particular pressed in, tightened or riveted, provides a particularly tight connection between the rod end and the press-fit nut or rivet nut, which does not loosen or become loose when the rod end is inserted in the vehicle seat, especially when it is connected to a holder by a screw element being screwed in.

In addition, a securing element may be provided. The securing element may, for example, be a U-profile, in particular a U-shaped clamping part. The securing element may be in the form of, for example, a securing bracket, which, after the holding rod is installed in a sleeve (also called holding sleeve or fastening sleeve), in particular in a plastics sleeve, is placed from the underside onto the holding rod with the inserted rivet nut and is then screwed to the holding rod.

The securing element has, for example, two limbs extending in the direction of the holding rod. The limbs extend in the direction of the holding rod along the outer side thereof, until they at least partially embrace the end of the sleeve on the outside. The free ends or the end faces of the limbs can be supported against the bearing surfaces of the sleeve.

In other words: the combination of the securing element and rivet nut at the free rod end allows the holding rod (also called head restraint rod) and the sleeve to be separated.

### DESCRIPTION OF THE FIGURES

The invention is explained in more detail below with reference to advantageous exemplary embodiments shown in the figures. However, the invention is not limited to these exemplary embodiments. In the figures:

FIG. 1: shows, in a schematic illustration, a vehicle seat with a longitudinal adjustment device,

FIG. 2: shows an exploded illustration of a holding rod according to the invention with a rivet nut,

FIG. 3: shows a partially sectioned view of the holding rod with an inserted rivet nut,

FIG. 4: shows a perspective view of the holding rod with an inserted rivet nut,

FIG. 5: shows a further perspective view of the holding rod with an inserted rivet nut,

FIG. 6: shows a side view of the holding rod attached to a holder of the vehicle seat,

FIG. 7: shows a sectional illustration of the holding rod attached to the holder of the vehicle seat,

FIG. 8: shows a perspective view of an example of a rivet nut,

FIG. 9: shows a further perspective view of the rivet nut, and

FIG. 10: shows a sectional illustration of a rivet nut joined to a free rod end of a holding rod.

### DETAILED DESCRIPTION

Mutually corresponding parts are provided with the same reference signs throughout the figures.

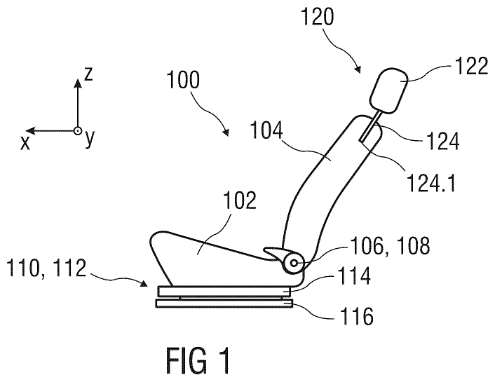

A vehicle seat 100 illustrated schematically in FIG. 1 in relation to the prior art will be described below using three spatial directions which extend perpendicularly to one another. In the case of a vehicle seat 100 installed in the vehicle, a longitudinal direction x extends substantially horizontally and preferably parallel to a vehicle longitudinal direction, which corresponds to the normal direction of travel of the vehicle. A transverse direction y which extends perpendicularly in relation to the longitudinal direction x is likewise oriented horizontally in the vehicle and extends parallel to a vehicle transverse direction. A vertical direction z extends perpendicularly in relation to the longitudinal direction x and perpendicularly in relation to the transverse direction y. In the case of a vehicle seat 100 installed in the vehicle, the vertical direction z preferably extends parallel to a vehicle vertical axis.

The positional and directional indications used, such as for example front, rear, top and bottom, relate to a viewing direction of an occupant seated on the vehicle seat 100 in a normal sitting position, the vehicle seat 100 being installed in the vehicle, in a use position suitable for passenger transport, with an upright backrest 104, and being oriented, as is customary, in the direction of travel. The vehicle seat 100 may, however, also be installed or moved in a different orientation, for example transversely to the direction of travel. Unless described otherwise, the vehicle seat 100 is constructed mirror-symmetrically with respect to a plane running perpendicularly in relation to the transverse direction y.

The backrest 104 can be arranged pivotably on a seat part 102 of the vehicle seat 100. For this purpose, the vehicle seat 100 may optionally comprise a fitting 106, in particular an adjustment fitting, rotary fitting, latching fitting or wobble fitting.

The positional and directional indications used, such as for example radial, axial and in the circumferential direction, refer to an axis of rotation 108 of the fitting 106. Radial means perpendicular to the axis of rotation 108. Axial means in the direction of or parallel to the axis of rotation 108.

The vehicle seat 100 may optionally comprise a longitudinal adjustment device 110. The longitudinal adjustment device 110 comprises, for example, a rail arrangement 112 having a first rail element 114 and a second rail element 116. The first rail element 114 is adjustable relative to the second rail element 116 in the longitudinal direction x. The first rail element 114 is fastened to the seat part 102. The second rail element 116 is fastened to a structural element of a vehicle, for example a vehicle floor.

For improved clarity, the first rail element 114 is referred to in the following description as upper rail 114. Said upper rail 114 (also referred to as running rail or carriage) is assigned to the vehicle seat 100 and is configured to support said vehicle seat 100. The second rail element 116 is referred to below as lower rail 116. The lower rail 116 is fixed and connected, for example, to the floor of a vehicle.

The vehicle seat 100 may comprise a head restraint 120. The head restraint 120 may, for example, comprise a head restraint body 122 for contact of a head of a user of the vehicle seat 100. The head restraint body 122 may be held on the vehicle seat 100 by a holding rod 124. The holding rod 124 may be in the form, for example, of an I-profile with a free rod end 124.1 or a U-profile (also called holding bracket) with two free rod ends 124.1.

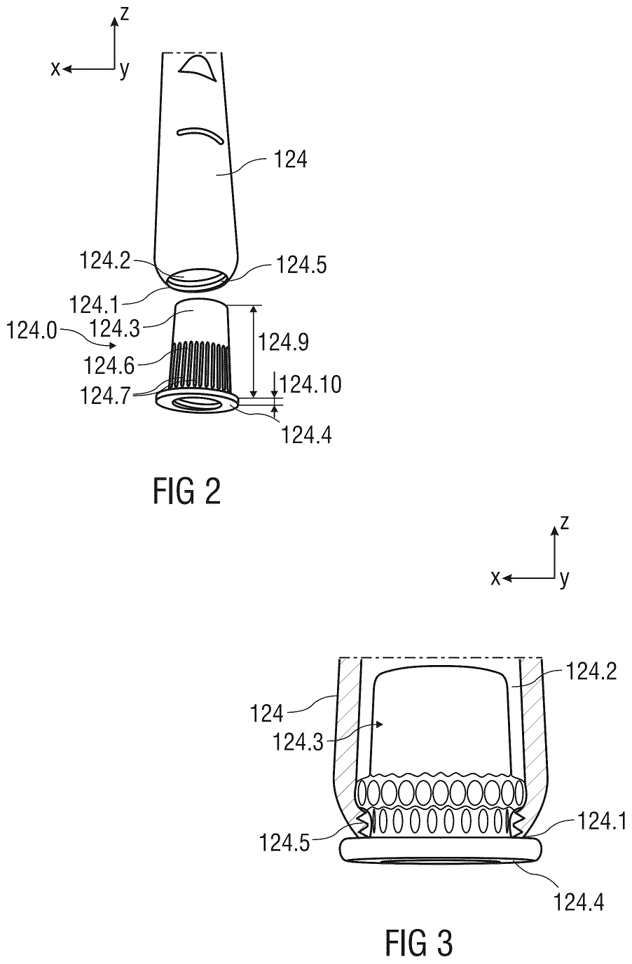

FIG. 2 shows an exploded illustration of the holding rod 124 according to the invention.

The holding rod 124 is provided with a hollow bore 124.2 at its free rod end 124.1 (also called accessible rod end). A mounting part 124.0 (also called insert part, insertion part, additional part or the like), for example a rivet nut 124.3, may be inserted into the hollow bore 124.2. Instead of a rivet nut 124.3, a press-fit nut may also be inserted into the hollow bore 124.2. The invention, in particular the mounting part 124.0, is described in more detail below, by way of example, using the rivet nut 124.3. The mounting part 124.0 is not limited to a rivet nut 124.3. The mounting part 124.0 may also be in the form of a press-fit nut or a clamping nut or the like.

The free rod end 124.1 of the holding rod 124 may, for example, be additionally countersunk, compressed, beveled, chamfered or undercut. This simplifies the insertion of the mounting part 124.0 into the hollow bore 124.2 and can be carried out in particular without clamping.

The mounting part 124.0 may in particular have an internal thread 124.8 (shown in FIG. 5).

The mounting part 124.0 may, for example, have an internal mounting portion 124.9, which, in the assembled state, is arranged in the hollow bore 124.2. Furthermore, the mounting part 124.0 may have an external portion 124.10, which, in the assembled state, protrudes from the hollow bore 124.2 of the holding rod 124 (as shown in FIGS. 3 to 7 and 10).

For example, the external portion 124.10 of the mounting part 124.0 may be in the form of a flange, in particular a contact flange for a screw element 128 (shown in FIG. 7) or an edge or the like protruding at a right angle.

The rivet nut 124.3 may be provided with a flat head 124.4, for example, on the external portion 124.10. In the joined state, the flat head 124.4 lies against the end face of a hollow bore edge 124.5 of the free rod end 124.1 (as shown in FIG. 3).

Alternatively, the rivet nut 124.3 may be provided with a countersunk head (not shown), which can be positioned in a hollow bore depression (not shown) of the free rod end 124.1.

In addition, the rivet nut 124.3 may be provided in sections on the outside with a profile 124.6, in particular with longitudinal grooves 124.7.

FIG. 3 shows a partially sectioned view of the holding rod 124 with an inserted rivet nut 124.3. The rivet nut 124.3 is inserted into the hollow bore 124.2 and joined, in particular riveted, to the free rod end 124.1. In the joined state, the flat head 124.4 of the rivet nut 124.3 lies against the end face of the hollow bore edge 124.5.

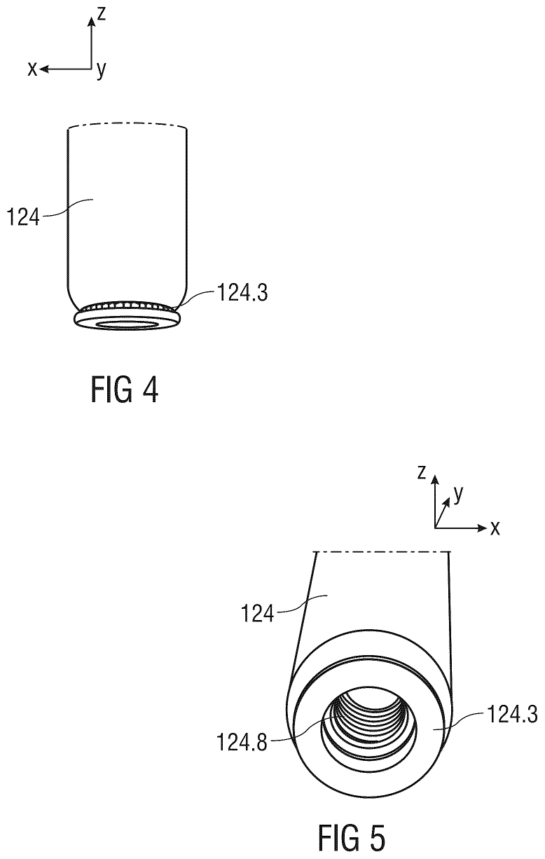

FIG. 4 shows a perspective view of the holding rod 124 with the inserted rivet nut 124.3 according to FIG. 3.

FIG. 5 shows a further perspective view of the holding rod 124 with the inserted rivet nut 124.3. The rivet nut 124.3 may be provided, for example, with an internal thread 124.8. For example, the internal thread 124.8 may be a standard thread, in particular an M9 thread or D9 thread.

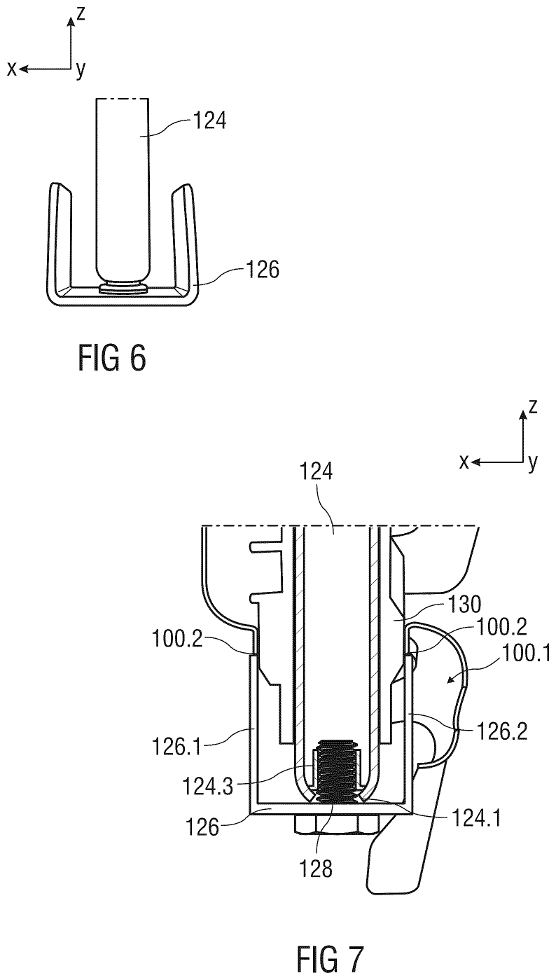

FIG. 6 shows a side view of a securing element 126 of the holding rod 124. The securing element 126 may, for example, be a U-profile, in particular a U-shaped clamping part. The securing element 126 is in particular a securing bracket, which, after the holding rod 124 is installed in sleeves 130, in particular in holding sleeves 130 (illustrated in FIG. 7), for example plastics sleeves, is placed from the underside onto the holding rod 124 with the inserted rivet nut 124.3 and is then screwed to the holding rod 124. Other forms of securing elements 126 are also suitable.

FIG. 7 shows a sectional illustration of the securing element 126 attached to the holding rod 124.

The vehicle seat 100 may comprise a frame 100.1 in which the holding rod 124 is held.

The free rod end 124.1 with the inserted rivet nut 124.3 is introduced and inserted into a sleeve 130, in particular a plastics sleeve, which is held in the frame 100.1.

The securing element 126 is placed from below onto the free rod end 124.1 with the inserted and joined rivet nut 124.3 and lies against the free rod end 124.1 and rivet nut 124.3. The holding rod 124 is connected to the securing element 126, in particular tightened onto the latter, by a screw element 128, which is screwed from the outside through the securing element 126 into the rivet nut 124.3. The screw element 128 may be, for example, a screw or a screw bolt.

The securing element 126, in particular in the form of a U-shaped safety bracket, has, for example, two limbs 126.1, 126.2 extending in the direction of the holding rod 124. The limbs 126.1, 126.2 extend in the direction of the holding rod 124 along the outer side thereof, until they at least partially embrace the end of the sleeve 130 on the outside. The free ends or the end faces of the limbs 126.1, 126.2 may be supported against end faces 100.2 of the frame 100.1, in particular a metallic seat frame.

In other words: the combination of the securing element 126 and rivet nut 124.3 at the free rod end 124.1 allows the holding rod 124 (also called head restraint rod) and the sleeve 130 to be separated. In addition, the securing element 126 may also be supported against a structural element of the vehicle seat 100.

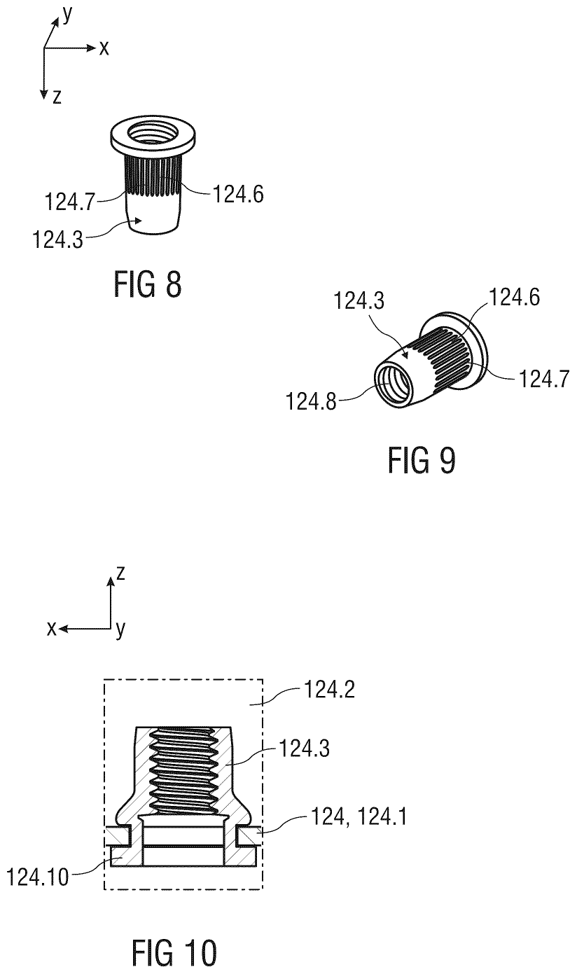

FIGS. 8 and 9 each show a perspective view of an example of the rivet nut 124.3 with the outer profile 124.6, in the form of longitudinal grooves 124.7, and the inner thread 124.8.

FIG. 10 shows a sectional illustration of the rivet nut 124.3 which is inserted into the hollow bore 124.2 and joined to the free rod end 124.1 of the holding rod 124 and riveted. The external portion 124.10 is in the form of a contact flange or contact surface. The external portion 124.10 is formed, for example, by a right-angled deformation, in particular a riveting, cross-shaping or the like, of the free end of the rivet nut 124.3.

### LIST OF REFERENCE SIGNS

100 Vehicle seat
100.1 Frame
100.2 End face
102 Seat part
104 Backrest
106 Fitting
108 Axis of rotation
110 Longitudinal adjustment device
112 Rail arrangement
114 First rail element (upper rail)
116 Second rail element (lower rail)
120 Head restraint
122 Head restraint body
124 Holding rod
124.0 Mounting part
124.1 Free rod end
124.2 Hollow bore
124.3 Rivet nut
124.4 Flat head
124.5 Hollow bore edge
124.6 Profile
124.7 Longitudinal grooves
124.8 Internal thread
124.9 Internal mounting portion
124.10 External portion
126 Securing element
126.1, 126.2 Limbs
128 Screw element
130 Holding sleeve, sleeve
x Longitudinal direction
y Transverse direction
z Vertical direction

What is claimed is:

1. A holding rod for a head restraint,
wherein the holding rod is provided with a hollow bore at a free rod end,
wherein a mounting part is inserted into the hollow bore and is joined to the free rod end.

2. The holding rod as claimed in claim 1, wherein the free rod end is additionally countersunk, compressed, beveled, chamfered or undercut.

3. The holding rod as claimed in claim 1, wherein the mounting part has an internal thread.

4. The holding rod as claimed in claim 1, wherein the mounting part has an internal mounting portion, which, in the assembled state, is arranged in the hollow bore, and an external portion.

5. The holding rod as claimed in claim 4, wherein the external portion is in the form of a flange or an edge protruding at a right angle.

6. The holding rod as claimed in claim 1, wherein the mounting part is provided with a profile in sections on the outside.

7. The holding rod as claimed in claim 1, wherein the mounting part is a press-fit nut or a rivet nut.

8. The holding rod as claimed in claim 7, wherein the press-fit nut is pressed into the hollow bore or the rivet nut is riveted into the hollow bore.

9. A head restraint having at least one holding rod as claimed in claim 1.

10. A vehicle seat having a head restraint as claimed in claim 9.
